(19) United States
(12) Patent Application Publication
(10) Pub. No.: US 2005/0014888 A1
(43) Pub. Date: Jan. 20, 2005

(54) Low gloss olefin

(75) Inventors: Deenadayalu Chundury, Newburgh, IN (US); Susan T. Schmidt, Evansville, IN (US); Daniel L. Evans, Boonville, IN (US); Christopher J. Brenner, Evansville, IN (US)

Correspondence Address: RANKIN, HILL, PORTER & CLARK, LLP, 925 EUCLID AVENUE, SUITE 700, CLEVELAND, OH, 44115-1405, US

(73) Assignee: Ferro Corporation, Cleveland, OH (US)

(21) Appl. No.: 10/884,007

(22) Filed: Jul. 2, 2004

Related U.S. Application Data
(60) Provisional application No. 60/486,544, filed on Jul. 11, 2003.

(51) Int. Cl. C08L 23/00; C08J 3/20

(52) U.S. Cl. 524/543

(57) ABSTRACT

The present invention provides low specular gloss polymeric compositions that exhibit good mechanical strength and methods of forming the same. According to the method of the invention, a masterbatch composition that includes fiberglass dispersed in a polypropylene homopolymer or copolymer is melt-mixed with a copolymer or homopolymer of polypropylene and a filler such as talc or calcium carbonate to form a polymer blend that exhibits low specular gloss and good mechanical properties.

### BACKGROUND OF THE INVENTION

1. Field of Invention

The present invention relates to a polymeric composition. More particularly, the present invention relates to a low-gloss olefin composition having improved mechanical strength.

2. Description of Related Art

Some thermoplastic polymer compositions, and particularly thermoplastic polymer compositions comprising styrenic polymers such as emulsion acrylonitrile-butadiene-styrene (“ABS”) polymers, naturally exhibit a high gloss finish when used to form articles by injection molding. Other thermoplastic polymers such as polypropylene, for example, exhibit a somewhat lower gloss finish. For many applications, a high gloss finish is a very desirable characteristic and it may be one of the most important factors in the selection of the material. On the other hand, for products such as automotive equipment and computer equipment, there is a trend toward matte or low gloss finishes. In automotive applications, low gloss finishes are particularly advantageous for safety reasons. Glare from high gloss thermoplastics can reduce visibility while operating an automobile.

Matte-surfaced or low-gloss polymers are thermoplastic materials that scatter light broadly from the surface instead of having a glossy surface with high reflectance. They may be clear, opaque, or colored, and may be formed into sheets or films of various thicknesses or more complex articles. One technique for obtaining low gloss is to use a textured mold surface. Textured molds are sometimes used to mold low gloss materials in order to further accentuate the dull finish. Using a high gloss product in a textured mold does not provide optimum results because the parts are not uniform over a long run. The mold surface tends to pick up material in different areas resulting in varying degrees of gloss over the surface of the parts. Elimination of gloss by surface embossing has been practiced but requires a separate step and adds cost. Moreover, subsequent abrasion may remove the embossed matte surface and cause the gloss to reappear.

The addition of a finely divided filler material, such as silica, silicate, aluminate, talc, calcium carbonate, or other similarly inert mineral, has been used to reduce the gloss of thermoplastic molding compositions. However, this is often accompanied by an undesirable reduction at least some physical and/or mechanical properties of the molded article, most notably the impact strength. In addition to the adverse effect on the impact strength, there is often a corresponding decline of the heat distortion temperature, decline in the weld line strength, deficient weathering and light stability, as well as other important properties. The mechanical properties may be degraded by the addition of relatively large amounts of filler material to the point where molded parts of such a highly filler-loaded polymer resin breaks during assembly or when dropped.

There have been other attempts to provide low gloss thermoplastics having improved physical and mechanical properties. For example, U.S. Pat. No. 5,190,828 to Katsumata discloses a low-gloss polymer composition that includes a polyacetyl base resin and a silicone graft copolymer. In theory, the gloss is reduced because the silicon in the silicon graft copolymer migrates to the surface of the article and gives the surface a roughened appearance.

U.S. Pat. No. 6,579,946 to Chau teaches that organic fillers can be used to reduce gloss and are typically added at less than 2% by weight of the composition. As noted above, the use of these additives tends to affect other film properties. Chau discloses a low gloss film including a vinyl aromatic polymer and less than 2% by weight of non-spherical rubber particles having a particle size of at least 2.5 μm. However, Chau is directed to films having a thickness of between 10 μm and 250 μm that are particularly useful as window films in envelopes.

Many of the aforementioned methods of reducing gloss have significant drawbacks negatively affecting the physical properties of the polymeric compositions. There exists a need for a method of reducing gloss without degrading the physical and mechanical properties of the polymeric composition.

### BRIEF SUMMARY OF THE INVENTION

The present invention provides a method of reducing gloss in polymeric compositions. Low gloss polymeric compositions formed in accordance with the present invention are suitable for applications where the use of polymers having a matte surface finish is advantageous such as, for example, some automotive applications. The polymeric compositions formed in accordance with the present invention exhibit improved low gloss characteristics and improved physical properties. Generally, the low gloss compositions are formed by melt mixing polypropylene with a masterbatch comprising about 30% by weight of fiberglass fibers having an average length of from about 1.0 mm to about 1.7 mm and an average diameter of from about 11 μm to about 17 μm dispersed in a polypropylene polymer. Fillers such as talc and calcium carbonate and other process additives may also be included in the compositions according to the invention.

Talc-filled low gloss polymeric compositions according to the present invention are formed by melt mixing from about 40% by weight to about 80% by weight of a polypropylene impact copolymer, from about 10% by weight to about 40% by weight talc, and from about 1% by weight to about 10% by weight of a masterbatch that comprises from about 20% by weight to about 40% by weight of the fiberglass fibers dispersed in a polypropylene polymer. Articles formed from talc-filled low gloss polymeric compositions according to the invention generally exhibit a specular gloss value of less than about 3.0 according to ASTM D2457-03, which is a standard test for specular gloss of plastic films and solid plastics.

Calcium carbonate-filled low gloss polymeric compositions according to the present invention are formed by melt mixing from about 30% by weight to about 70% by weight of a polypropylene homopolymer, from about 30% by weight to about 50% by weight calcium carbonate, and from about 1% by weight to about 10% by weight of a masterbatch that comprises from about 20% by weight to about 40% by weight of the fiberglass fibers dispersed in a polypropylene polymer. Articles formed from calcium carbonate-filled low gloss polymeric compositions according to the invention generally exhibit a specular gloss value of less than about 37 according to ASTM D2457-03.

Fillers such as talc have been used in the past to reduce gloss in polymeric compositions, but their use has previously produced detrimental effects on the physical properties of such compositions. The low gloss compositions of the present invention employ a fiberglass masterbatch to reduce gloss. When low gloss compositions were formed using the method of the present invention, decreased gloss values and improved mechanical strength of the polymeric compositions resulted.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

The present invention provides a low-gloss polymeric compositions and a method of forming the same. Low gloss polymeric compositions formed in accordance with the present invention exhibit improved low gloss characteristics and improved physical properties as compared to conventional compositions. Generally, low gloss compositions according to the invention are formed by melt mixing a polypropylene-based polymer and a filler together with a masterbatch composition comprising from about 20% to about 40% by weight of fiberglass fibers having an average length of from about 1.0 mm to about 1.7 mm and an average diameter of from about 11 μm to about 17 μm dispersed in a polypropylene homopolymer or copolymer. Examples of suitable fillers for use in the invention include talc and calcium carbonate.

Talc-filled compositions according to the present invention are generally formed by melt mixing from about 40% by weight to about 80% by weight of a polypropylene impact copolymer, from about 10% by weight to about 40% by weight talc, and from about 1% by weight to about 10% by weight of a fiberglass masterbatch composition comprising from about 20% to about 40% by weight of fiberglass fibers having an average length of from about 1.0 mm to about 1.7 mm and an average diameter of from about 11 μm to about 17 μm dispersed in a polypropylene homopolymer or copolymer. More preferably, talc-filled compositions according to the invention are formed by melt mixing from about 60% to about 75% by weight of a polypropylene impact copolymer with from about 20% to about 30% by weight talc and from about 3% to about 8% by weight of a masterbatch comprising from about 25% to about 35% by weight of fiberglass fibers having an average length of from about 1.0 mm to about 1.7 mm and an average diameter of from about 11 μm to about 17 μm dispersed in a homopolymer or copolymer of polypropylene. The polypropylene impact copolymer preferably comprises a minor amount (from about 10 to about 25% by weight) of ethylene repeat units. Polypropylene impact copolymers of this type are widely available from a variety of suppliers. The talc used in the composition preferably has a particle size of from about 2 μm to about 15 μm. Articles formed from the talc filled composition according to the invention exhibit a specular gloss value of less than about 3.0 according to ASTM D2457-03.

Calcium carbonate-filled compositions according to the present invention are generally formed by melt mixing from about 30% by weight to about 70% by weight of a polypropylene homopolymer, from about 30% by weight to about 50% by weight calcium carbonate, and from about 1% by weight to about 10% by weight of a fiberglass masterbatch composition comprising from about 20% to about 40% by weight of fiberglass fibers having an average length of from about 1.0 mm to about 1.7 mm and an average diameter of from about 11 μm to about 17 μm dispersed in a polypropylene homopolymer or copolymer. More preferably, calcium carbonate filled compositions formed using the method of the present invention are formed by melt mixing from about 45% to about 60% by weight of a polypropylene homopolymer with from about 35% to about 45% by weight calcium carbonate and from about 3% to about 8% by weight of a masterbatch comprising from about 25% to about 35% by weight of fiberglass fibers having an average length of from about 1.0 mm to about 1.7 mm and an average diameter of from about 11 μm to about 17 μm dispersed in a homopolymer or copolymer of polypropylene. Articles formed from the calcium carbonate filled composition according to the invention have a gloss value of less than about 37 according to ASTM D2457-03.

As noted above, the fiberglass masterbatch composition comprises fiberglass fibers that are dispersed in a homopolymer or copolymer of polypropylene. The fiberglass masterbatch composition preferably comprises from about 20% to about 40% by weight of fiberglass fibers, and more preferably from about 25% to about 35% by weight fiberglass fibers. The presently most preferred masterbatch composition for use in the invention is available as GAPEX® RPP30EA36HBNA from Ferro Corporation of Cleveland, Ohio. This formulation contains about 30% by weight of fiberglass fibers having an average diameter of about 14 μm and an aspect ratio of about 10 dispersed within a chemically-coupled, heat-stabilized polypropylene homopolymer.

The low-gloss polymeric compositions preferably comprise no more than about 2% by weight fiberglass, as higher concentrations of fiberglass can negatively affect the physical and mechanical properties of the polymeric compositions. Preferred embodiments of the present invention contain from about 1.0% to about 1.5% by weight fiberglass. It is difficult to evenly disperse and distribute such small amounts of fiberglass in polymeric compositions. If dry fiberglass fibers alone (i.e., fibers that are not dispersed in a polymer to form a masterbatch composition) are melt mixed with the other components of the low gloss polymeric compositions, the glass fibers tend to orient themselves relative to one another and do not evenly disperse within the polymeric composition. This results in poor consistency and a diminution in physical properties.

To ensure a more precise addition and an even distribution of the small amount of fiberglass fibers, the fiberglass must be added to the bulk of the polymers in the form of a masterbatch composition. For example, adding 5% by weight of a masterbatch composition comprising 30% by weight of fiberglass fibers dispersed in a polypropylene carrier results in a low gloss polymeric composition having a 1.5% by weight concentration of fiberglass. Because the fiberglass is contained within the masterbatch composition, melt mixing the masterbatch along with the bulk polypropylene polymer and other components of the low gloss composition results in a more even distribution of fiberglass and a desired random orientation of the glass fibers relative to each other.

During melt mixing with a polypropylene homopolymer or copolymer, filler, and other optional components, many of the glass fibers within the fiberglass masterbatch composition break into smaller fibers. Accordingly, the glass fibers in the masterbatch composition tend to have a greater average length than the glass fibers in the resulting low-gloss compositions of the invention. As noted, the length of the glass fibers in the masterbatch composition is in the range of from about 1.0 mm to about 1.7 mm and the average diameter is from about 11 μm to about 17 μm, meaning that the fibers have an aspect ratio of about 10 or greater. After the masterbatch composition is combined with the bulk polymers and fillers to form the low gloss compositions according to the invention, the average length of the glass fibers is reduced to between about 0.9 mm and about 1.4 mm.

Without being held to any particular theory, applicants believe that the fiberglass reduces the specular gloss of the polymeric compositions of the present invention. It was found that adding fiberglass in the form of a masterbatch composition resulted in a more random orientation of the glass fibers than when dry fiberglass fibers alone were added. It is applicants' theory that the reduced aspect ratio of the glass fibers in combination with the random orientation of the fibers and even dispersion of the fibers scatters light in all directions, resulting in improved low gloss values. The composition of the fibers is probably not critical, but use of a material in the masterbatch composition that has an initial (i.e., pre-processed) aspect ratio of 100 or greater appears to be critical.

Applicants have also found that in addition to the fiberglass fibers, the incorporation of a relatively small amount of silica further reduces the specular gloss of the resulting low gloss polymer composition. Silica additions of from about 1% by weight to about 15% by weight, and more preferably from about 2.5% to about 12.5% by weight are suitable for this purpose. The silica is preferably an untreated, granulated, precipitated silica having a relatively high surface area (e.g., from about 150-200 m²/g surface area).

As noted, the low gloss polymer compositions according to the present invention may comprise one or more fillers. Preferably, the polymer compositions comprise from about 5% to about 50% by weight of the one or more fillers. The preferred fillers are talc and calcium carbonate. Other fillers and fibers conventionally used to prepare polymer compositions can also be used.

Other additives may be included in the polymer compositions according to the present invention to modify or to obtain desirable properties. For example, stabilizers and inhibitors of oxidative, thermal and ultraviolet light degradation may be included in the polymer blends as well as lubricants and mold release agents, colorants including dyes and pigments, nucleating agents, plasticizers, flame retardants, etc., may be included in the polymer compositions.

The stabilizers can be incorporated into the composition at any stage in the preparation of the polymer blends, and preferably, the stabilizers are included early to preclude the initiation of the degradation before the composition can be protected. The oxidative and thermal stabilizers useful in the polymer blends of the present invention include those used in addition polymers generally. They include, for example, up to about 1% by weight, based on the weight of the polymer blend, of Group I metal halides such as sodium, potassium, lithium and cuprous halides (e.g., chloride, bromide, and iodide), hindered phenols, hydroquinones, and various substituted derivatives of these materials and combinations thereof.

The ultraviolet light stabilizers may be included in amounts of up to about 2% by weight based on the weight of the polymer blend. Examples of ultraviolet light stabilizers include various substituted resorcinols, salicylates, benzotriazoles, benzophenones, etc.

Suitable lubricants and mold release agents may be included in amounts of up to about 1% by weight based on the weight of the polymer blend include materials such as stearic acid, stearic alcohol, stearic acid salts, stearamides, organic dyes such as nigrosine, pigments such as titanium dioxide, cadmium sulfide, carbon black, etc. The plasticizers which may be included in amounts of up to about 5% by weight based on the weight of the polymer blend include materials such as dioctylphthalate, bibenzylphthalate, butylbenzophthalate, hydrocarbon oils, sulfonamides such as paratoluene ethyl sulfonamides, n-butylbenzene sulfonamide, etc.

A particularly preferred composition according to the invention comprises a melt-mixed polymer blend composition comprising from about 45% to about 55% by weight of a polypropylene-ethylene impact copolymer, from about 10% to about 30% by weight of an ethylene-octene copolymer, from about 5% to about 25% by weight of talc, from about 2.5% to about 12.5% by weight of precipitated silica, from about 0.25% to about 0.5% by weight of ethylene bis-stearamide wax, from about 0.25% to about 0.5% by weight of calcium stearate and from about 0.5% to about 2.0% by weight of fiberglass fibers having an average length of from about 0.9 mm to about 1.4 mm and an average diameter of from about 11 μm to about 17 μm. Melt-mixed polymer blends of this type typically exhibit a 60° specular gloss value of less than about 20 according to ASTM D2457-03.

The following examples are intended only to illustrate the invention and should not be construed as imposing limitations upon the claims.

### EXAMPLE 1

A talc filled low gloss polymeric composition according to the present invention (Composition B) was formed by melt mixing the following components listed in Table 1 below and processing the polymeric composition on a 2.5″ single screw extruder. A conventional talc filled polymeric composition (Composition A) was also prepared in the same manner for comparative purposes.

TABLE 1

| Component | Composition A | Composition B |
|---|---|---|
| Polypropylene Copolymer, 20 Melt | 73.276 | 68.276 |
| Flow Rate | | |
| 10 Micron Appearance Grade Talc | 25.000 | 25.000 |
| Hindered Phenolic Stabilizer | 0.100 | 0.100 |
| Distearyl Thiodipropionate | 0.300 | 0.300 |
| Zinc Stearate/Zinc Dibutyl | 0.500 | 0.500 |
| Dithiocarbamate (80/20 Blend) | | |
| Hindered Amine Stabilizer | 0.200 | 0.200 |
| UV absorber | 0.100 | 0.100 |
| Bisphenol A/Epoxy Derivative | 0.300 | 0.300 |
| Color Components | 0.674 | 0.674 |
| 30% Fiberglass Polypropylene | 0.000 | 5.000 |
| Masterbatch | | |
| Total | 100.000 | 100.000 |

As noted above, Composition A is considered to be a conventional low gloss composition whereas Composition B is a novel low gloss composition according to the invention because it contains 5% by weight of a masterbatch composition comprising 30% (by weight) fiberglass dispersed in polypropylene (GAPEX® RPP30EA36HBNA from Ferro Corporation). Articles formed from Composition A had a tangent modulus value of 1,834 Mpa, while articles formed from Composition B had a tangent modulus value of 2,025 Mpa. Composition A had a heat deformation temperature (HDT) of 117° C., and Composition B had an HDT of 131° C. It is clear that Composition B has superior mechanical properties compared to Composition A. The 60° specular gloss was measured according ASTM D2457-03. Composition A had a gloss value of 2.8, and Composition B had a gloss value of 2.2. Thus, in addition to the improved physical properties, Composition B also had a reduction in specular gloss compared to Composition A.

### EXAMPLE 2

Calcium carbonate filled low gloss polymeric Compositions C and D were separately formed by melt mixing the following components listed in Table 2 below and processing the polymeric compositions on a 2.5″ single screw extruder.

TABLE 2

| Component | Composition C | Composition D |
|---|---|---|
| Polypropylene Homopolymer, 12 | 57.174 | 52.174 |
| Melt Flow Rate | | |
| Calcium Carbonate | 38.000 | 38.000 |
| Hindered Phenolic Stabilizer | 0.100 | 0.100 |
| Distearyl Thiodipropionate | 0.300 | 0.300 |
| Zinc Stearate/Zinc Dibutyl | 0.100 | 0.100 |
| Dithiocarbamate (80/20 Blend) | | |
| Hindered Amine Stabilizer | 0.400 | 0.400 |
| UV absorber | 0.200 | 0.200 |
| Lubricant/Processing Aid | 0.750 | 0.750 |
| Calcium Stearate | 0.500 | 0.500 |
| Pigment | 0.006 | 0.006 |
| Titanium Dioxide | 2.470 | 2.470 |
| 30% Fiberglass Polypropylene | 0.000 | 5.000 |
| Masterbatch | | |
| Total | 100.000 | 100.000 |

Composition C is considered to be a conventional low gloss composition. Inventive Composition D contains 5% by weight of a masterbatch comprising 30% (by weight) of fiberglass dispersed in polypropylene (GAPEX® RPP30EA36HBNA from Ferro Corporation). Articles formed from Composition C had a tangent modulus value of 340,000 psi, while articles formed from Composition D had a tangent modulus value of 382,000 psi. Composition C had a heat deformation temperature (HDT) of 100.5° C., and Composition D had an HDT of 116.1° C. It is clear that Composition D has superior mechanical properties compared to Composition C. The 60° specular gloss was measured according ASTM D2457-03. Composition C had a gloss value of 40, and Composition D had a gloss value of 36. In addition to the improved physical properties, Composition D also had a reduction in specular gloss compared to Composition C.

### EXAMPLE 3

Talc filled low gloss polymeric Compositions E and F were separately formed by melt mixing the following components listed in Table 3 below and processing the polymeric compositions on a 2.5″ single screw extruder.

TABLE 3

| Component | Composition E | Composition F |
|---|---|---|
| Polypropylene Copolymer, 18 Melt | 52.050 | 52.050 |
| Flow Rate | | |
| Ethylene-alpha-olefin copolymer | 20.000 | 20.000 |
| 2.0 Micron Appearance Grade Talc | 20.000 | 10.000 |
| Precipitated Silica | 0.000 | 10.000 |
| Hindered Phenolic Stabilizer | 0.100 | 0.100 |
| Bisphenol A/Epoxy Derivative | 0.100 | 0.100 |
| Lubricant/Processing Aid | 0.375 | 0.375 |
| Calcium Stearate | 0.375 | 0.375 |
| Carbon Black | 1.000 | 1.000 |
| 30% Fiberglass Polypropylene | 5.000 | 5.000 |
| Masterbatch | | |
| Total | 100.000 | 100.000 |

Compositions E and F both contain 5% by weight of a masterbatch comprising 30% (by weight) of fiberglass dispersed in polypropylene (GAPEX® RPP30EA36HBNA from Ferro Corporation). However, Composition F included 10% by weight of a precipitated silica (granulated, 185 m²/g surface area, untreated) in place of a similar amount of talc (as compared to Composition E). Articles formed from Compositions E and F both had a non-breaking izod. The 60° specular gloss was measured according ASTM standard D 2457-03. Composition E had a gloss value of 39, and Composition F had a gloss value of 13. Thus, Composition F exhibited a significant reduction in specular gloss as compared to Composition E without a reduction in impact strength.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A method of forming a talc-filled polymer blend composition comprising melt mixing from about 40% to about 80% by weight of a polypropylene impact copolymer, from about 10% to about 40% by weight talc, and from about 1% by weight to about 10% by weight of a masterbatch composition comprising
from about 20% to about 40% by weight of fiberglass fibers having an average length of from about 1.0 mm to about 1.7 mm and a diameter of from about 11 μm to about 17 μm dispersed in carrier comprising polypropylene,
together to form a melt mixture that when processed and tested in accordance with ASTM D2457-03 exhibits a 60° specular gloss value of less than about 3.0.

2. The method of claim 1 wherein the polypropylene impact copolymer comprises from about 10% to about 25% by weight of ethylene.

3. The method of claim 1 wherein the talc has a particle size of from about 2 μm to about 15 μm.

4. The method of claim 1 wherein the melt mixture further comprises additives selected from the group consisting of stabilizers, antioxidants, ultraviolet absorbers, lubricants and pigments.

5. The method of claim 1 wherein the fiberglass fibers in the masterbatch composition have an average length of from about 0.9 mm to about 1.4 mm after melt mixing.

6. The method of claim 1 wherein the melt mixture further comprises from about 1% to about 17.5% by weight of precipitated silica.

7. A method of forming a calcium carbonate-filled polymer blend comprising melt mixing from about 30% by weight to about 70% by weight of a polypropylene homopolymer, from about 30% by weight to about 50% by weight calcium carbonate, and from about 1% by weight to about 10% by weight of a masterbatch composition comprising
from about 20% to about 40% by weight of fiberglass fibers having an average length of from about 1.0 mm to about 1.7 mm and a diameter of from about 11 μm to about 17 μm dispersed in carrier comprising polypropylene,
together to form a melt mixture that when processed and tested in accordance with ASTM D2457-03 exhibits a 60° specular gloss value of less than about 37.

8. The method of claim 7 wherein the melt mixture further comprises additives selected from the group consisting of stabilizers, antioxidants, ultraviolet absorbers, lubricants and pigments.

9. The method of claim 7 wherein the fiberglass fibers in the masterbatch composition have an average length of from about 0.9 mm to about 1.4 mm after melt mixing.

10. The method of claim 7 wherein the melt mixture further comprises from about 1% to about 17.5% by weight of precipitated silica.

11. A polymer blend composition comprising:
from about 40% by weight to about 80% by weight of a polypropylene impact copolymer;
from about 10% by weight to about 40% by weight talc; and
from about 0.5% to less than about 2.0% by weight of fiberglass fibers having an average length of from about 0.9 mm to about 1.4 mm;

12. The polymer blend composition according to claim 11 wherein the polypropylene impact copolymer comprises from about 10% to about 25% by weight of ethylene.

13. The polymer blend composition according to claim 11 wherein the talc has a particle size of from about 5 microns to about 15 microns.

14. The polymer blend composition according to claim 11 further comprising additives selected from the group consisting of stabilizers, antioxidants, ultraviolet absorbers, lubricants and pigments.

15. The polymer blend composition according to claim 11 further comprising from about 1% to about 17.5% by weight of precipitated silica.

16. A polymer blend composition comprising:
from about 30% by weight to about 70% by weight of a polypropylene homopolymer;
from about 30% by weight to about 50% by weight calcium carbonate; and
from about 0.5% to less than about 2.0% by weight of fiberglass fibers having an average length of from about 0.9 mm to about 1.4 mm;
wherein the polymer blend exhibits a 60° specular gloss value of less than about 37 according to ASTM D2457-03.

17. The polymer blend composition according to claim 16 further comprising additives selected from the group consisting of stabilizers, antioxidants, ultraviolet absorbers, lubricants and pigments.

18. The polymer blend composition according to claim 16 further comprising from about 1% to about 17.5% by weight of precipitated silica.

19. A melt-mixed polymer blend composition comprising:
from about 45% to about 55% by weight of a polypropylene-ethylene impact copolymer;
from about 10% to about 30% by weight of an ethylene-octene copolymer;
from about 5% to about 25% by weight of talc;
from about 2.5% to about 12.5% by weight of silica;
from about 0.25% to about 0.5% by weight of ethylene bis-stearamide wax;
from about 0.25% to about 0.5% by weight of calcium stearate; and
from about 0.5% to about 2.0% by weight of fiberglass fibers having an average length of from about 0.9 mm to about 1.4 mm and an average diameter of from about 11 μm to about 17 μm,
wherein the melt-mixed polymer blend composition exhibits a 60° specular gloss value of less than about 20 according to ASTM D2457-03.

20. A component for a motor vehicle formed by injection molding the melt-mixed polymer blend composition according to claim 19.
